(19) United States
(12) Patent Application Publication
(10) Pub. No.: US 2005/0217034 A1
(43) Pub. Date: Oct. 6, 2005

(54) Spackling kit and tool

(75) Inventors: Jared Miller, North Ridgeville, OH (US); Marcelo Orchon, Cleveland, OH (US); Matthew M. Graif, Springfield, MO (US); John E. Schnoebelen JR., Springfield, MO (US)

Correspondence Address: Thomas E. Young, Esq.;Fay, Sharpe, Fagan, Minnich & McKee, LLP, Seventh Floor, 1100 Superior Avenue, Cleveland, OH, 44114-2518, US

(73) Assignee: Henkel Consumer Adhesives, Inc.

(21) Appl. No.: 11/094,060

(22) Filed: Mar. 30, 2005

Related U.S. Application Data
(60) Provisional application No. 60/558,687, filed on Apr. 1, 2004.

(51) Int. Cl. B25F 1/00

(52) U.S. Cl. 7/170

(57) ABSTRACT

A spackling tool includes a card material configured in the shape of a putty knife and an abrasive material provided on one side of the tool. A spackling kit can include the aforementioned spackling tool and a container retained adjacent the tool. The container has spackling compound disposed therein. The container can be retained adjacent the hand tool by adhering the container to the hand-tool and/or by packaging the kit such that a packaging layer retains the container adjacent the hand tool. The spackling container can be in the form of a sealed pouch or a tub. A method for manufacturing a spackling kit is also provided.

This application claims the benefit of provisional patent application Ser. No. 60/558,687 filed Apr. 1, 2004.

BACKGROUND

Holes in drywall have been repaired by applying spackling compound to the area in need of repair. Typically, a putty knife having a metal blade attached to a wooden or plastic handle is used to spread the spackling compound over the area in need of repair. After the spackling compound has dried, the repaired area is sanded. To perform this repair operation, a consumer typically purchases three separately sold items: a putty knife, sand paper and a container of spackling compound.

Attempts have been made to provide tools and kits that can be purchased as a single retail item and that combine some of the tools and/or items required for a spackling repair operation. One such combination tool includes a combination cap and spackling tool. The cap covers a tube of spackling compound and a blade is integrally formed with the cap. A user of this combination tool removes the cap from the cylindrical tube of spackling compound, applies the spackling compound to either the area to be repaired or the blade, and then spreads the compound with the blade. Sand paper may still be needed to smooth the repaired area.

Another combination tool includes a resilient sheet that is formed in the shape of a putty knife and a blister-like sealed container filled with spackling compound that attaches to one side of the resilient sheet. The blister pack retains the spackling compound against the tool-shaped sheet and keeps the spackling compound from drying out. An opening is provided in a blade portion of the putty knife-shaped resilient sheet and a plug is selectively positioned inside the opening. Spackling compound is provided on the blade by pressing on the blister pack and forcing the spackling compound through the opening in the blade. Spackling compound can then be spread by the blade in the area of the wall to be repaired. Sand paper may still be needed to smooth the repaired area.

### SUMMARY OF THE INVENTION

A spackling tool includes a card material configured in the shape of a putty knife and an abrasive material provided on one side of the tool. A spackling kit can include the aforementioned spackling tool and a container retained adjacent the tool. The container has spackling compound disposed therein. The container can be retained adjacent the hand tool by adhering the container to the hand tool and/or by packaging the kit such that a packaging layer retains the container adjacent the hand tool. The spackling container can be in the form of a sealed pouch or a tub.

A method of manufacture of a spackling kit includes the following steps: producing a hand tool from a sheet material, where the hand tool includes a blade portion, a first surface and a second surface; adhering an abrasive material to the first surface of the hand tool; positioning a container having spackling compound disposed therein adjacent the hand tool; and packaging the hand tool and the compartment into a retail unit.

A single use spackling kit is also described. The disposable kit includes a hand tool, an abrasive material disposed on a first surface of the hand tool, and a sealed container of spackling compound retained adjacent the hand tool.

### BRIEF DESCRIPTION OF THE FIGURES

FIG. 1 is a plan view of a first side of a spackling tool showing an abrasive material disposed on the first side.

FIG. 2 is a plan view of a second, opposite, side of the tool of FIG. 1 showing a container of spackling compound retained adjacent the second side.

FIG. 3 is a side elevation view of the tool of FIG. 1 and the spackling container of FIG. 2 packaged into a spackling kit retail unit.

FIG. 4 is an alternative embodiment of a spackling kit showing a hand tool and an alternative embodiment of a container of spackling compound.

### DETAILED DESCRIPTION

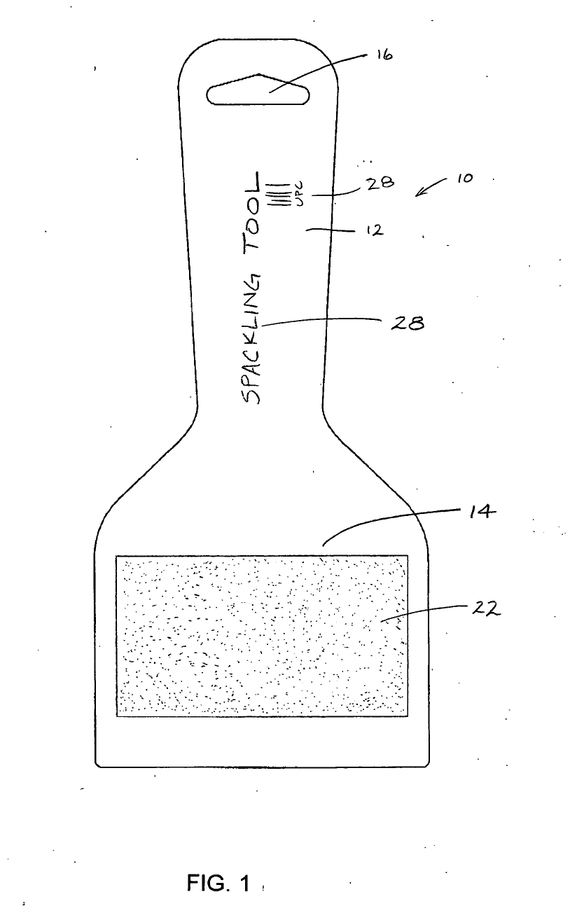

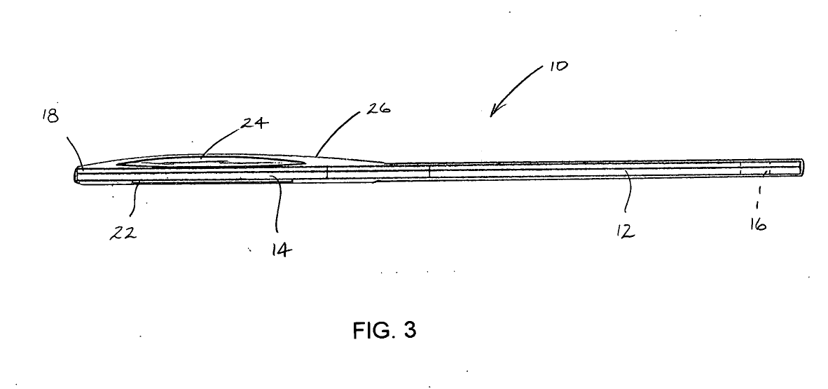

With reference to FIG. 1, a hand tool 10 for spreading spackling compound, or similar materials, includes a handle portion 12 and a blade portion 14. As more clearly visible in FIG. 3, the hand tool 10 is generally planar in configuration. In the depicted embodiment, the hand tool is made from a blister card and/or laminated paper material. Alternatively, the hand tool can be made from other materials such as plastic and the like. The hand tool should have sufficient stiffness and thickness so that the hand tool can be used to spread spackling compound.

As is apparent in FIG. 1, the hand tool 10 is shaped similarly to a spatula or putty knife used to spread spackling compound. The handle 12 is configured to provide an area where a user of the hand tool can grip the tool. The handle can be longer or shorter than that shown in the figures. The handle also includes a hole 16 near an end opposite the blade portion 14. The hole 16 is provided for hanging the tool on a peg at retail displays. The blade portion 14 is wider than the handle portion 12. The blade portion 14 will typically be used to spread the spackling compound over the area in need of repair.

As seen in FIG. 3, the hand tool 10 can include a smooth plastic layer 18 on at least one side of the hand tool 10. A plastic coating can also be applied to the opposite side of the hand tool 10. The plastic coating can provide a smooth surface to facilitate applying spackling compound.

An abrasive material 22 is applied to one of the planar surfaces of the hand tool 10. In the embodiment shown in FIG. 3, the adhesive material 22 is disposed on a surface that is opposite the smooth plastic surface 18. However, as mentioned above, a smooth plastic layer can be applied to both sides of the tool and in such a configuration the adhesive material can be applied over the smooth material. The abrasive material 22 can include a sheet of sand paper. Also, the adhesive material can comprise a sanding screen or other abrasive material. The abrasive material will be used to sand dried spackling compound that has been applied to the area in need of repair. In the embodiment depicted in FIGS. 1 and 3, the abrasive material 22 is disposed in the blade portion 14 of the hand tool 10. By providing the abrasive material 22 in the blade portion 14, a large sanding surface can be provided. Nevertheless, the abrasive material can be located elsewhere such as on the handle portion 12 or on both the blade portion and the handle portion.

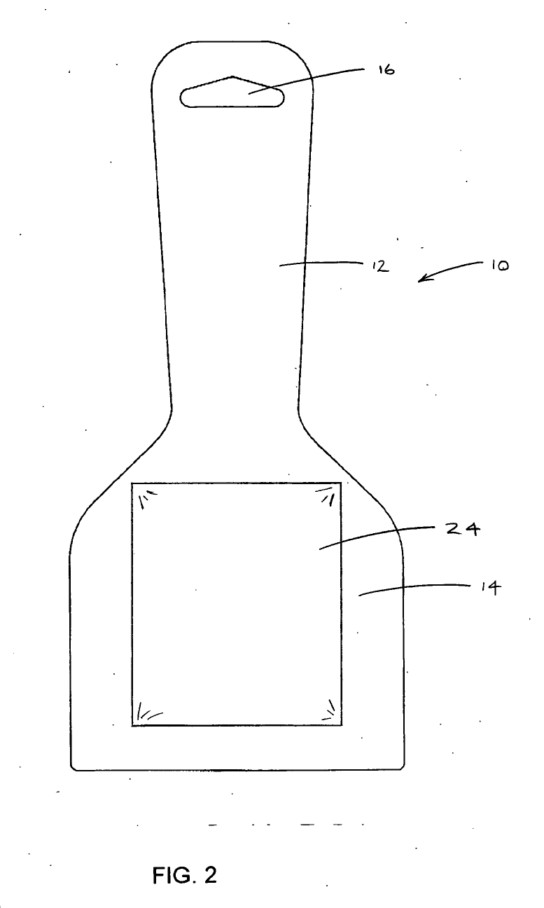

With continued reference to FIG. 3, where the hand tool is provided in a spackling kit, a container 24 of spackling compound can be retained against a planar surface of the hand tool 10. In the embodiment depicted in FIG. 3, the spackling container 24 is held against the planar surface that is opposite the surface to which the abrasive material is applied. In the embodiment shown in FIG. 2 and 3, the spackling container 24 comprises a sealed packet that contains spackling compound. The sealed packet can be adhered to a planar surface of the hand tool 10.

With reference to FIG. 3, a packaging layer 26 can also retain the packet 24 next to a planar surface of the hand tool 10. The packaging layer 26 can be a plastic layer, such as those widely used in blister pack packaging, to hold the packet 24 against the hand tool 10. Also, the packaging layer can also be a plastic wrap material, such as polyethylene and the like. The plastic layer can be transparent or translucent to provide the consumer the opportunity to view the contents of the retail unit, i.e. the hand tool 10 and the spackling container 24, before purchasing the retail unit. A blister card, which is not shown, can also be provided as part of the spackling kit packaging. The hand tool 10 can be retained against the blister card by the packaging layer 26. The packaging layer 26 can surround the entire hand tool 10 and packet 24 or the packaging layer 26 can simply surround a portion of the hand tool and a portion of the packet 24 to retain the packet against the hand tool.

With reference back to FIG. 1, product marketing indicia 28 can be applied by printing to one or both planar sides of the hand tool 10. This product marketing indicia includes product use directions, universal product code information, pricing information, product source information, and other information.

When repairing a wall or other surface, the user of the spackling kit unwraps the tool 10 from the packaging 26 and opens the packet 24 that contains the spackling compound. The spackling compound is applied to the area to be repaired or the blade portion 14 of the hand tool 10. The hand tool 10 is used to apply and/or spread the spackling compound. After the spackling compound has dried, the adhesive material 22 is used to smooth the dried spackling compound. After the job has been finished, the entire kit can be discarded.

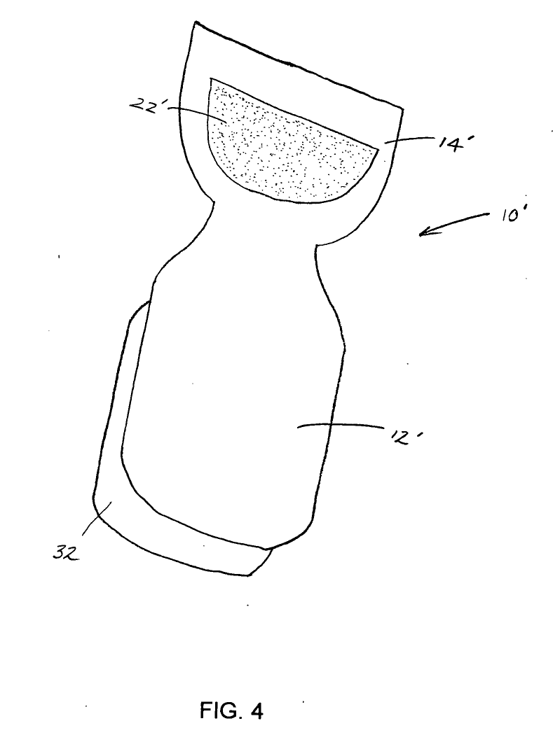

An alternative embodiment of a spackling kit is shown in FIG. 4, where like numerals having a primed (′) suffix refer to like components of the embodiment depicted in FIGS. 1-3. A hand tool 10′ includes a handle portion 12′ and a blade portion 14′. The tool 10′ is a substantially planar member similar to the embodiment disclosed in FIG. 1-3. Furthermore, the hand tool can be made from similar materials. An abrasive material 22′, similar to that described above, can be applied to a side of the hand tool.

A spackling compound container 32 can be retained against a planar surface of the hand tool 10′. In this embodiment, the spackling container 32 comprises a tub. The tub can be of a similar configuration to a single serving butter or jelly tub found in many restaurants. The tub 32 can include a removable lid, which in this embodiment is formed from a portion of the handle portion 12′ of the hand tool 10′. In an alternative embodiment, the tub 32 can include a removable lid that is adhered to the hand tool 10 and/or retained adjacent the hand tool 10 by a packaging layer, similar to the packaging layer 26 described with reference to FIG. 3.

Even though two examples of spackling compound containers have been described with particularity, the containers of spackling compound can take other configurations. It may be desirable, however, to provide a container of spackling compound that includes only a small amount of spackling compound, e.g. enough to fix several small holes that remain after picture hanging nails have been removed from a wall. By providing a small amount of spackling compound, after the repairs have been made there is little, if any, spackling compound left to dry out and be wasted.

A spackling hand tool and a spackling kit that includes the hand tool has been described with reference to the depicted embodiments. The spackling kit can provide all the items that are typically used in a spackling repair operation. Modifications and alterations will occur to those who are skilled in the art after reading the preceding description. The preceding description was supplied simply to teach one skilled in the art how to make and use the invention and to provide the best mode contemplated by the inventors. The description should not limit the invention to only those depicted embodiments. Instead, the invention is defined by the appended claims and the equivalents thereof.

1. A spackling kit comprising:
a substantially planar hand tool comprising a blade portion, a first surface and an opposed second surface;
an abrasive material disposed on the first surface of the hand tool;
a container retained adjacent the hand tool; and
spackling compound disposed in the container.

2. The kit of claim 1, wherein the hand tool further comprises a handle portion, wherein the blade portion is wider than the handle portion.

3. The kit of claim 1, wherein the abrasive material comprises sand paper, and the sand paper is adhered to the blade portion.

4. The kit of claim 1, further comprising a smooth plastic layer disposed on the second surface at least in the blade portion.

5. The kit of claim 1, wherein the container comprises a sealed pouch.

6. The kit of claim 5, wherein the pouch is adhered to the hand tool.

7. The kit of claim 5, further comprising a packaging layer, the packaging layer at least partially retaining the pouch against the hand tool.

8. The kit of claim 7, wherein the packaging layer comprises a transparent or translucent plastic layer.

9. The kit of claim 1, wherein the container comprises a tub.

10. The kit of claim 9, wherein the tub includes a removable lid, and the removable lid is adhered to the hand tool.

11. The kit of claim 9, further comprising a packaging layer, wherein the packaging layer at least partially retains the tub against the hand tool.

12. The kit of claim 9, wherein the tub includes a removable lid and the hand tool forms at least a portion of the removable lid.

13. The kit of claim 1, wherein the hand tool comprises a laminated sheet material.

14. The kit of claim 13, wherein the hand tool includes an opening extending through the laminated sheet material.

15. The kit of claim 1, wherein the hand tool comprises a blister card material.

16. The kit of claim 15, further comprising product marking indicia applied to the second surface.

17. A method of manufacturing a spackling kit, the method comprising:
producing a hand tool from a sheet material, the hand tool comprising a blade portion, a first surface and a second surface;
adhering an abrasive material to the first surface of the hand tool;
positioning a container having spackling compound disposed therein adjacent the hand tool; and
packaging the hand tool and the container into a retail unit.

18. The method of claim 17, wherein the step of packaging results in the container being retained against the hand tool.

19. A spackling tool:
a card material configured in the shape of a putty knife; and
sandpaper adhered to a side of the card material.

20. The spackling kit of claim 19, wherein the card material comprises a smooth surface adapted for spreading spackling material opposite the surface to which the sandpaper is adhered.

21. A single use spackling kit comprising:
a hand tool;
an abrasive material disposed on a first surface of the hand tool; and
a sealed container of spackling compound retained adjacent the hand tool.
